(19) United States
(12) Patent Application Publication
(10) Pub. No.: US 2011/0120809 A1
(43) Pub. Date: May 26, 2011

(54) COLLISION BRAKE FOR TWO ELEVATOR BODIES MOVING INDEPENDENTLY OF ONE ANOTHER

(76) Inventors: Hans Kocher, Udligenswil (CH); Michael Stubi, Buchrain (CH)

(21) Appl. No.: 12/808,063

(22) PCT Filed: Dec. 10, 2008
(86) PCT No.: PCT/EP2008/067170

§ 371 Date: Sep. 8, 2010

(30) Foreign Application Priority Data
Dec. 14, 2007 (EP) 07123281.3

(51) Int. Cl. B66B 5/16; B66B 9/00

(52) U.S. Cl. 187/249; 187/351

(57) ABSTRACT

A collision brake for two elevator bodies, which move independently of one another, includes a first locking mechanism, which is disposed between the two elevator bodies and is fastened on a first of the two elevator bodies, and which has a brake body arrangement having at least one first brake body, which is movably mounted in the first locking mechanism toward a guide structure. The first locking mechanism has a positive guide, which converts a relative movement of the brake body arrangement in an ascension direction by the second of the two elevator bodies into a relative movement of the brake body arrangement on the guide structure.

### FIELD OF THE INVENTION

The present invention relates to a collision brake for two elevator bodies moving independently of one another, particularly elevator cars or counterweights, as well as to an elevator system with two elevator bodies moving independently of one another and such a collision brake.

### BACKGROUND OF THE INVENTION

Elevator systems are known from, for example, EP 1 577 250 A1, in which two or more elevator cars move independently of one another in the same elevator shaft. Through an appropriate drive control of the individual elevator cars the elevator system can be more efficiently utilized overall and at the same time collision of the individual cars with one another prevented. For this purpose, for example, a lower elevator car only has to move within the region below an elevator car arranged thereabove and this, conversely, only has to serve a region above the lower elevator car. However, the risk of collision with such a control-based collision avoidance system is present to the extent that the control has faulty operation or fails.

EP 1 577 250 A1 therefore proposes a hydraulic collision brake, which is fastened to an upper side of a lower elevator car or to a lower side of an upper elevator car. The collision brake has on each of its upper side and lower side a respective hydraulic collision detector in which, through a colliding elevator car, a hydraulic pressure is increased which opens hydraulic valves, whereby hydraulically released, spring-biased brake wedges are applied and thus fix the collision brake to the guide rails of the elevator system by friction couple. The collision forces of the colliding elevator cars are then dissipated by way of the collision brake directly into these guide rails. However, this collision brake is constructionally complicated and susceptible to fault.

### SUMMARY OF THE INVENTION

An object of the present invention is therefore to provide an improved collision brake for two elevator bodies moving independently of one another.

A collision brake according to the invention is provided for an elevator system in which two or more elevator cars move independently of one another in the same elevator shaft, the same guide or the like. The elevator bodies can be, in particular, elevator cars which move independently of one another in the same elevator shaft or in the same guide.

In order to reduce lifting work as well as, in the case of drive pulley elevators, to ensure a sufficient drive capability of a looped-around drive pulley, elevator cars can be coupled with balance weights or counterweights. Such counterweights can also be arranged, with at least partial coincidence of their maximum travel paths, in the same elevator shaft or the same guide and thus form equivalent elevator bodies in the sense of the present invention, between which a collision brake according to the invention can be arranged.

A collision brake according to the invention can thus be equally arranged between two elevator cars following one another in travel direction and/or between two counterweights following one another in travel direction, which cover at least in part the same travel path.

A collision brake according to the invention comprises at least one first locking mechanism, which is arranged between the two elevator bodies and fastened to a first one of the two elevator bodies. The locking mechanism comprises a brake body arrangement with at least one first brake body which is so mounted in the first locking mechanism that it is movable relative to a guide structure, i.e. can be brought selectably into and out of contact therewith.

According to the invention the first locking mechanism has a positive guide which converts a relative movement of this brake body arrangement in its disposition, which is mechanically imposed on the brake body arrangement by the second of the two elevator bodies in a collision direction, into a relative movement of the brake body arrangement at the guide structure.

If the two elevator bodies move onto one another this causes, from a predetermined minimum distance, a relative movement of the brake body arrangement of the first locking mechanism in the collision direction. The positive guide converts this relative movement into a relative movement of the brake body arrangement at the guide structure and thus brings the brake body arrangement into frictionally locking contact with the guide structure. The first locking mechanism and with it the first elevator body connected therewith are thereby supported at the guide structure by friction lock so that the inertia forces of the first elevator body are not or at least not completely carried into the second elevator body, but are dissipated at least partly into the guide structure by way of the closed frictional contact.

The positive guide in that case ensures frictional engagement of the locking mechanism with the guide structure, since if the minimum spacing between first and second elevator body is fallen below, i.e. in the event of running of the two elevator bodies onto one another, the brake body arrangement of the first locking mechanism is displaced in the collision direction and—by way of the positive guide—in that case brought into friction-locking contact with the guide structure. A high level of security against failure of the collision brake can thereby be guaranteed with a simple constructional format and at the same time an unintended, faulty application of the collision brake avoided as long as the two lift elevator bodies do not run onto one another.

In a particularly preferred embodiment of the present invention a locking mechanism, which is arranged between the two elevator bodies, is also fastened to the second of the two elevator bodies. This second locking mechanism also comprises a brake body arrangement with at least one first brake body mounted in the second locking mechanism to be movable relative to the guide structure, the second locking mechanism similarly having a positive guide which converts a relative movement of the brake body arrangement in the disposition in the second locking mechanism in a collision direction, which is mechanically imposed by the first elevator body, into a relative movement of this brake body arrangement at the guide structure.

In this preferred embodiment the brake body arrangement of the second locking mechanism is thus also brought into frictional engagement with the guide structure by virtue of the positive guide when the two brake bodies fall below a predetermined spacing from one another, i.e. run onto one another. Inertia forces of the second elevator body are thus supported at least partly, similarly with frictional locking, at the guide structure and thus diminish the collision forces introduced into the first elevator body.

For preference the first and/or in a given case a second locking mechanism is or are so constructed that the brake body arrangement thereof directly or indirectly contacts the second or first elevator body as soon as the spacing of the two elevator bodies reaches or falls below a predetermined minimum distance. On further approach of the two elevator bodies to one another one of the two elevator bodies then moves the brake body arrangement of the locking mechanism at the other elevator body in the collision direction and thus brings this brake body arrangement into friction-locking contact with the guide structure.

A direct contact between brake body arrangement and elevator body in that case simplifies the constructional form, whilst an indirect contact, for example by way of lever mechanisms or the like, makes possible conversion of a collision path into a larger or smaller relative movement of the brake body arrangement.

If locking mechanisms are provided at both elevator bodies the second locking mechanism can be so constructed that on approach of the two elevator bodies the brake body arrangements thereof come into direct or indirect contact and thus produce the relative movements of the brake body arrangements in the collision direction. The two elevator bodies here come into contact with one another by their brake body arrangements so that the respective locking mechanisms are closed as early as possible.

In a preferred embodiment of the present invention the brake body arrangement of the first and/or in a given case a second locking mechanism respectively comprises a first and a second brake body, the brake bodies being so mounted in the respective locking mechanism that they are movable relative to one another and to the guide structure. If such a brake body arrangement is displaced in the collision direction, then the first and second brake bodies are pressed in opposite direction against the guide structure so that two frictional contacts are produced by oppositely acting normal forces. The guide structure and locking mechanism can thereby advantageously be symmetrically loaded, which reduces the loading of the components and simplifies the constructional format. In addition, the locking mechanism can center itself at the guide structure.

The first and second brake bodies can be released by resilient action, particularly by one or more release springs, i.e. biased away from the guide structure. Thus, a normally released collision brake is created in simple manner, the brake being applied only in the case of collision, i.e. by the imposing of a relative movement of the brake body arrangement in collision direction against the releasing springs. Thus, a reliable application of the brake in the case of collision and a release of the brake in the case of sufficient spacing of the two elevator bodies from one another can equally be guaranteed. Advantageously, this takes place in reversible manner, since the energy for release of the brake in the case of collision is stored by the stressing of the air springs and subsequently reused under relaxation of the springs. There is thus no need for a further energy supply, particularly no electrical current supply or the like at risk of failure. This is a further advantage of a collision brake according to the invention in which the locking mechanism can be actuated by way of the positive guide purely mechanically and thus without an external energy source.

The positive guide, which converts a relative movement of a brake body arrangement in the collision direction into a relative movement at the guide structure, can be constructed as, for example, a link guide in which one or more brake bodies, advantageously resiliently mounted, are mechanically positively guided in such a manner that in a case of displacement in collision direction they move towards the guide structure and come into contact therewith. In a preferred embodiment the link guide is constructed as a parallelogram guide, which in the case of displacement in collision direction at the same time moves the brake body arrangement towards the guide structure. The risk of jamming of the positive guide and thus blocking of the collision brake can be reduced by such a parallelogram guide.

The first and second brake bodies of a brake body arrangement can be so coupled together, for example by way of an entrainer pin on which two brake bodies are mechanically positively guided, that an advance movement of one of the two brake bodies at the guide structure produces an advance movement, in particular symmetrically with respect thereto, of the other one of the two brake bodies. Additionally or alternatively the advance movement of the two brake bodies can also be effected via the positive guide of the brake body arrangement. As a result, the locking mechanism is advantageously engaged as soon as even only one of the two brake bodies is displaced in the collision direction.

It a preferred embodiment of the present invention the brake body arrangement has self-locking co-operation with the guide structure when it bears thereagainst. If a force which seeks to displace the brake body at the guide structure against the friction forces acting there is imposed on such a brake body arrangement the friction forces counteracting this force produce a further advance of the brake body at the guide structure, i.e. an increase in the normal forces acting in the friction contact and thus a strengthening of the friction couple.

If, for example, the positive guide is constructed as a parallelogram guide then this can advantageously be so dimensioned that the parallelogram guide forms together with the normals to the collision direction an angle which is smaller than or equal to half the opening angle of the friction cone between the brake body arrangement and the guide structure: according to Newton there arises in a friction contact with the coefficient of friction μ, which is loaded by a normal force FN a friction force FR which is directed oppositely to the acting tangential force in the friction contact and has the maximum value: FR=μ×FN. The resultant of normal force and friction force thus describes the so-called friction cone, half the opening angle of which corresponds with the arctangent FR/FN, i.e. arctan(p). As long as the resultant acting in the friction contact between brake body and guide structure lies within this friction cone the brake body frictionally adheres to the guide structure and on exceeding this adhesive force reserve the brake body begins to slide at the guide structure, wherein in addition energy is dissipated by sliding friction forces.

If the angle between the parallelogram guide and the normals to the guide structure is now less than half the opening angle of the friction cone, the resultant, which is imposed in the direction of the parallelogram guide, of the guide forces of the parallelogram guide on the brake bodies lies within the friction cone, so that static friction is reliably present.

In a preferred embodiment of the present invention the first and/or in a given case a second locking mechanism is or are fastened to or supported at the respective elevator body by way of at least one spring element and/or at least one damper element. The course of the forces introduced into the locking mechanism in a case of running onto can advantageously be preset by a spring element. Thus, for example, a progressively acting spring element can initially brake the elevator body gently and with increasing strength in the case of further progress in the running onto. In particular, if the locking mechanism is so designed that static friction arises early and the brake body arrangement adheres to the guide structure, the elevator body can be gently braked under deflection of the spring element. Advantageously, energy can be dissipated by a damper element during the running onto. For this purpose the damper element can comprise, for example, a rubber element which dissipates energy under deformation, a mechanical damper which dissipates energy by friction or a hydraulic and/or pneumatic damper which dissipates energy by flow losses of a flowing fluid, particularly an oil or gas.

The speeds of elevator bodies are usually monitored by an elevator control, which applies emergency brakes of the respective body in the case of exceeding specific maximum speeds. The anticipated maximum impact speed between two elevator bodies therefore lies in a range, for example, between 0.5 m and 1.5 m per second. Advantageously, the spring element and/or damper element is or are therefore so constructed that in a case of a collision speed in this range a deceleration readily tolerable by passengers and components of the elevator system arises, the deceleration lying, for example, between 0.5 g and 2 g, preferably between 0.8 g and 1.5 g and particularly preferably in the range of approximately 1 g. In that case “g” denotes the gravitational acceleration of approximately 9.81 m/s².

Advantageously a substantially constant deceleration can then be realized by appropriate matching of the spring element or damping element, wherein, particularly at the beginning and end of the process of running onto, stronger or weaker levels of deceleration can also take place.

The first and/or in a given case a second locking mechanism can be fixedly connected with the respective elevator body, for example by way of the spring element and/or damper element, i.e. particularly also fixed in the normal plane relative to the guide structure. Equally, the locking mechanism can also be mounted at the elevator body to be floating and supported thereagainst only in the collision direction.

The guide structure can comprise one or more guide rails which, for example, are arranged in an elevator shaft. This guide structure, with which the first and/or second locking mechanism co-operates or co-operate, can advantageously be employed additionally to the guidance of the elevator bodies. In particular, elevator cars or counterweights can travel at guide rails with which the collision brake co-operates.

### DESCRIPTION OF THE DRAWINGS

Further advantages and features of the present invention are evident from the following exemplifying embodiments, which with respect thereto and partly schematically:

FIG. 1 shows a collision brake according to an embodiment of the present invention, in the released state;

FIG. 2 shows the collision brake according to FIG. 1 with elevator bodies moved up to one another;

FIG. 3 shows a first locking mechanism of the collision brake according to FIG. 1;

FIG. 4 shows the first locking mechanism according to FIG. 3 in the moved-onto state according to FIG. 2;

FIG. 5 shows the locking mechanism of FIG. 4, wherein a guide structure is excluded;

FIG. 6 shows the locking mechanism of FIG. 3 in a perspective view; and

FIG. 7 shows a first locking mechanism of a collision brake according to a further embodiment of the present invention.

### DESCRIPTION OF PREFERRED EMBODIMENTS

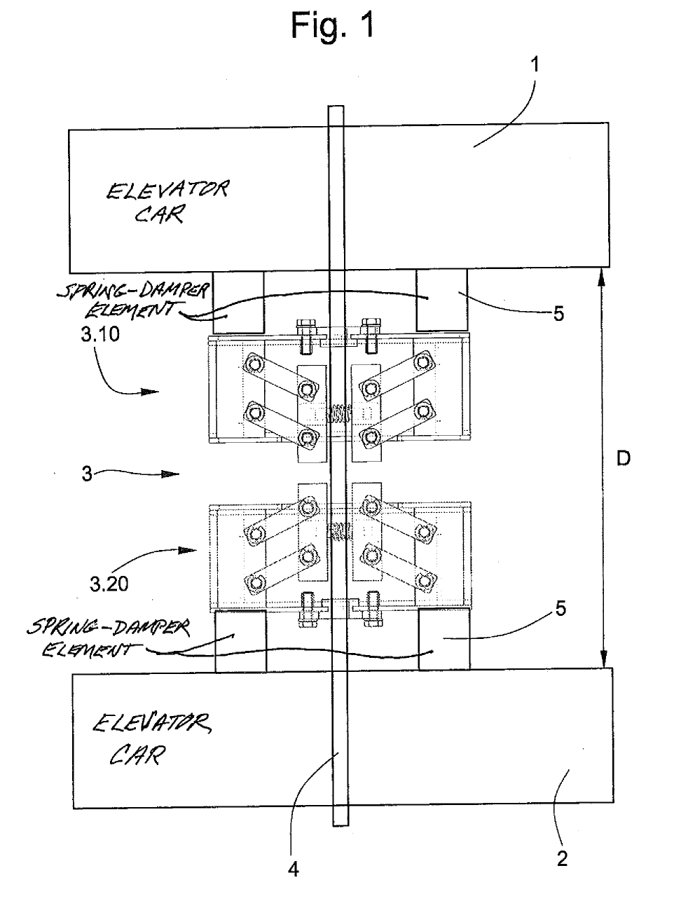

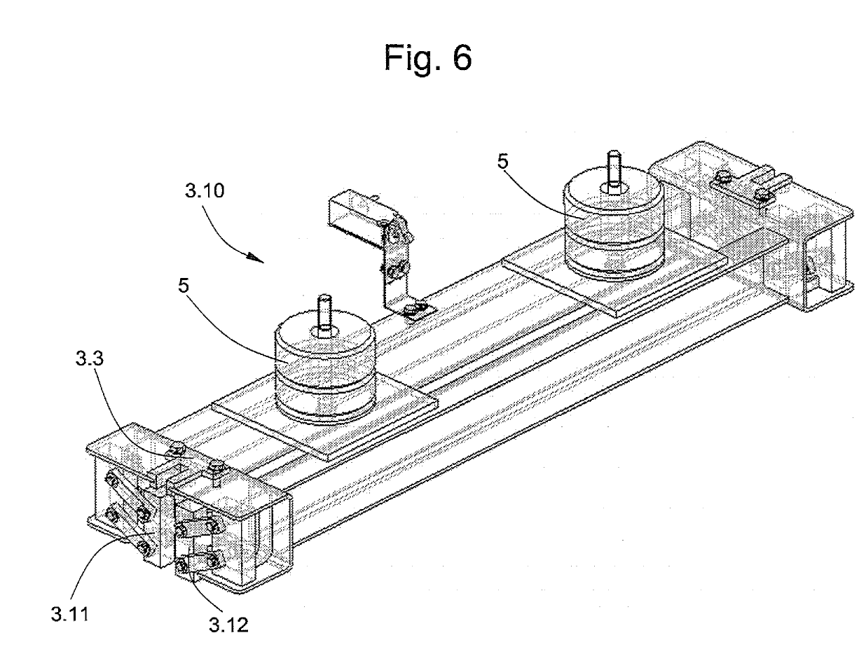

FIG. 1 shows a collision brake 3 according to an embodiment of the present invention, in side view. It comprises a first locking mechanism 3.10, which is supported by way of spring-damper elements 5 relative to the floor of a first elevator body in the form of an upper elevator car 1, which is shown only partly in FIG. 1. The spring-damper elements 5 comprise, in a manner not illustrated in more detail in FIG. 1, rubber buffers which by virtue of their resilience act as a spring element and by virtue of the energy dissipation on deformation simultaneously act as a damper element. They are, as shown in FIG. 6, of annular construction and guided on rods. In addition, the first locking mechanism 3.10, as similarly recognizable in FIG. 6, is detachably fastened to the floor of the upper elevator car 1 by means of screw connections.

The collision brake 3 further comprises a second locking mechanism 3.20 which is identical in construction to the first locking mechanism 3.10 and therefore not explained in more detail in the following. It is supported in analogous manner by way of spring-damper elements 5 relative to the roof of the second elevator body in the form of a lower elevator car 2, which is similarly illustrated only partly in FIG. 1.

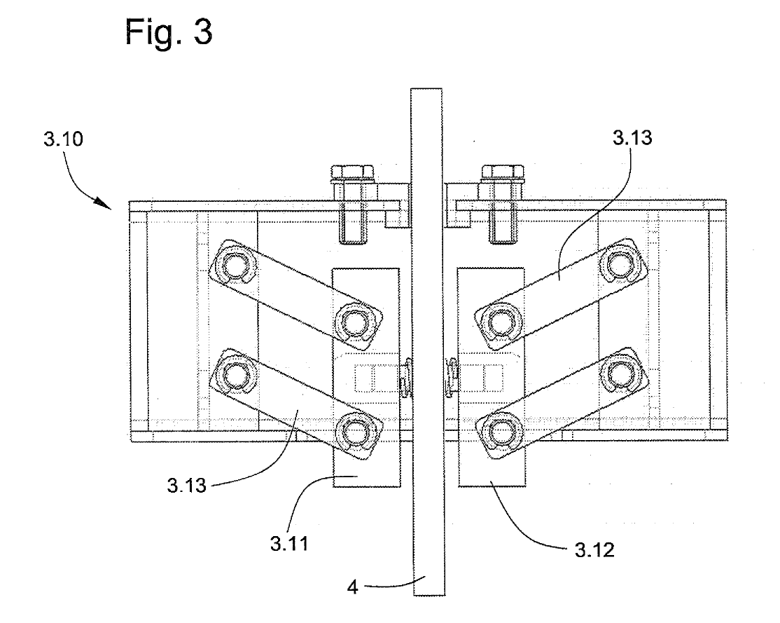

With reference to FIG. 3, the first locking mechanism 3.10 comprises a brake body arrangement consisting of a first brake body 3.11 and a second brake body 3.12 opposite thereto. The two brake bodies 3.11, 3.12 of this brake body arrangement are movably mounted in the locking mechanism 3.10 by means of a parallelogram guide 3.13. If the brake bodies 3.11, 3.12 of the brake body arrangement are displaced, on running of the upper and lower elevator cars 1, 2 onto one another, by the lower elevator car 2 in collision direction (upwardly in FIG. 3), the parallelogram guide 3.13 acting as positive guide causes an advance movement of the first and second brake bodies 3.11, 3.12 towards a guide structure in the form of a guide rail 4. In that case “collision direction” designates the movement direction of the brake body arrangement in the reference system of the locking mechanism in the case of a collision, thus for the upper elevator car 1 in the exemplifying embodiment vertically upwardly towards the elevator car 1.

The second locking mechanism 3.20 is constructed identically to the form of embodiment shown in FIG. 1, so that it is not described in more detail in the following, but reference can be made to the explanations with respect to the first locking mechanism 3.10 and only differences are discussed insofar as necessary. The second locking mechanism is so arranged with respect to a normal plane to the guide rail 4, i.e, a plane perpendicular to the drawing plane of FIG. 1, in mirror image to the first locking mechanism 3.10 so that the projecting first and second brake bodies of the brake body arrangements of the two locking mechanisms face one another and first come into contact with one another when the upper elevator car 1 and the lower elevator car 2 run onto one another. In this case the collision direction for the second locking mechanism 3.20 fastened to the lower elevator car 2 is oriented downwardly towards the lower elevator car 2, since the brake body arrangement in the case of a collision moves vertically downwardly towards the elevator car 2.

In a modified form of embodiment (not illustrated) the second locking mechanism 3.20 is oriented identically to the first locking mechanism 3.10. The parallelogram guide 3.13 in the released state is thus similarly swept back downwardly like the first locking mechanism 3.10. Since in the case of a collision the brake body arrangement of the identically constructed and identically oriented second locking mechanism 3.20 is similarly vertically displaced upwardly, the collision direction in the second locking mechanism is similarly vertically upwards towards the elevator car 1.

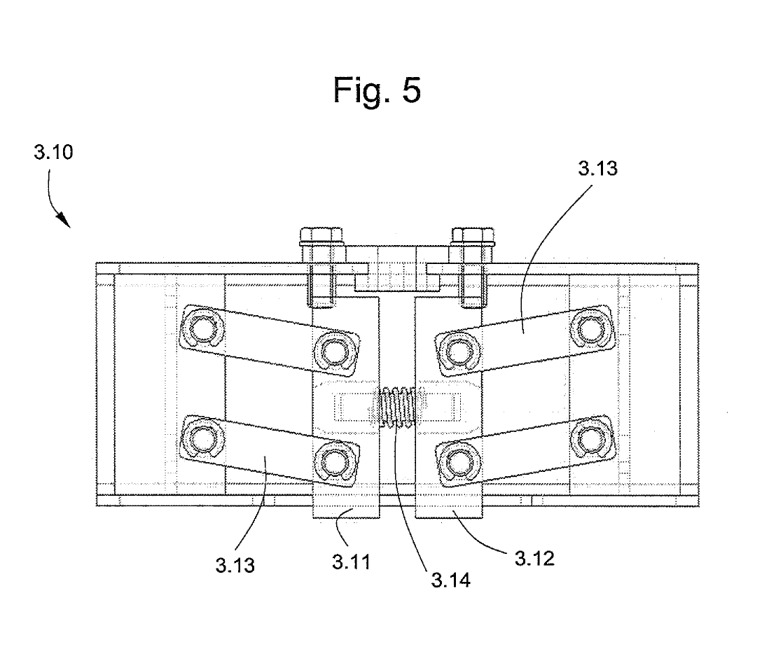

The two brake bodies 3.11, 3.12 of the two brake body arrangements of the two locking mechanisms 3.10, 3.20 respectively engage on either side around a lefthand guide rail 4 and are, in the released state, spaced therefrom so that the locking mechanisms 3.10, 3.20 can move freely along this guide rail 4. For this purpose two brake bodies 3.11, 3.12, as apparent particularly from FIG. 5, are biased away from one another by a release spring 3.14, which encloses an entrainer pin engaging through the two brake bodies 3.11, 3.12 perpendicularly to the collision direction. This entrainer pin produces, together with the parallelogram guide 3.13, an advance movement of one of the two brake bodies 3.11, 3.12 towards the guide rail 4 when the other one of the two brake bodies 3.11, 3.12 is moved towards the guide rail 4.

The first locking mechanism 3.10 is thus released not only by the release spring 3.14, but also by the action of gravitational force. The same applies to the second locking mechanism 3.20 in the modified form of embodiment (not illustrated). In the form of embodiment illustrated in FIG. 1, in which the second locking mechanism 3.20 is constructed in mirror image, i.e. the parallelogram guide 3.13 is swept back upwardly so that the brake bodies of the second locking mechanism 3.20 protrude upwardly towards the upper elevator car 1, the brake body arrangement is thereagainst released by the release spring against gravitational force.

As long as the two elevator cars 1, 2 have a spacing from one another which amounts to at least a minimum distance D (cf. FIG. 1) the two locking mechanisms 3.10, 3.20 are completely released, i.e. the collision brake 3 is released, as is illustrated in FIGS. 1, 3. The collision brake in that case slides along the guide rail 4, wherein the first locking mechanism 3.10 moves with the upper elevator car 1, the second locking mechanism 3.20 independently thereof together with the lower elevator car 2.

For this purpose the two locking mechanisms have, as apparent particularly from FIG. 6, U-shaped guide counter-members 3.3 which embrace the guide rail 4 from three sides and thus guide the locking mechanism. On the opposite end face, which is symmetrically constructed and therefore not explained in more detail, each locking mechanism has, similarly recognizable from FIG. 6, a corresponding arrangement of first and second brake bodies as well as guide counter-members, which embrace a righthand guide rail parallel to the lefthand guide rail 4 and not visible in FIGS. 1 to 5.

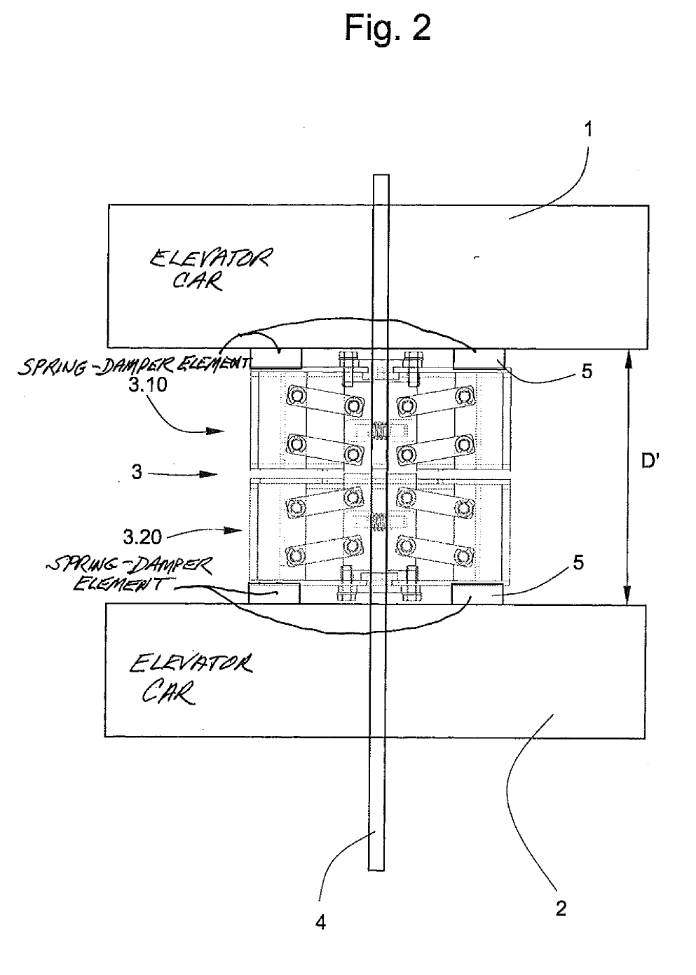

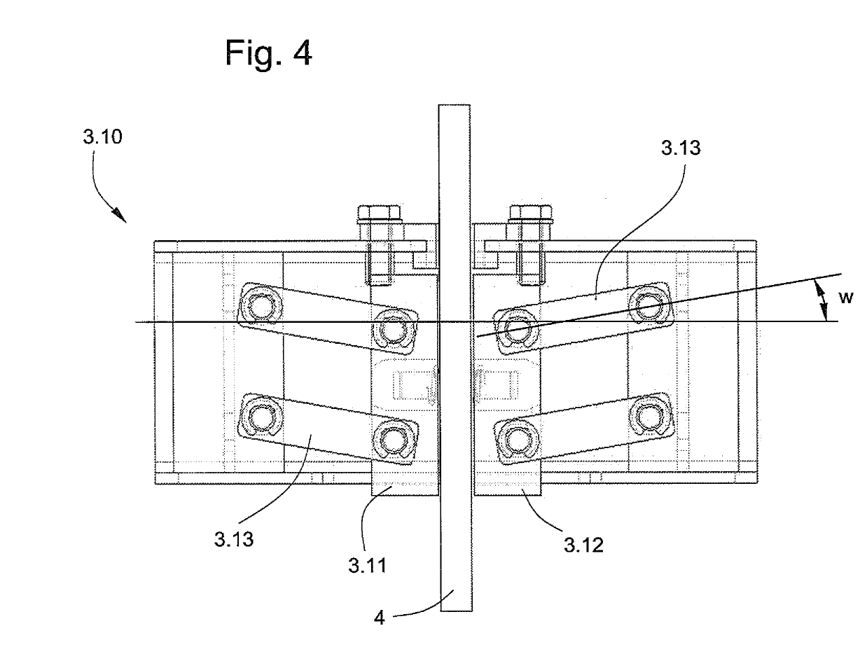

If the upper elevator car 1 and the lower elevator car 2 approach one another due to, for example, a fault in the elevator control, which controls the two elevator cars 1, 2 independently of one another, in such a manner that the spacing thereof falls below the minimum distance D illustrated in FIG. 1, as is illustrated in FIGS. 2, 4, then the brake bodies of the brake body arrangements are displaced in the respective collision direction. In the modified form of embodiment (not illustrated) all brake bodies of the two locking mechanisms 3.10, 3.20 are in each instance displaced upwardly, i.e. the collision direction is the same for the two locking mechanisms. In the embodiment illustrated in FIG. 2 initially the protruding, mutually facing brake bodies of the two locking mechanisms 3.10, 3.20 contact one another. As a result, on further movement of the elevator cars 1, 2 onto one another the brake bodies 3.11, 3.12 of the first locking mechanism 3.10 are displaced towards the upper elevator car 1, i.e. upwardly in a collision direction. In the mirror-image second locking mechanism the corresponding brake bodies are displaced towards the lower elevator car 2, i.e. downwardly in a collision direction.

The brake bodies are thereby respectively brought, by virtue of the positive guidance, by the parallelogram guide 3.13, into friction-locking engagement with the lefthand guide rail 4 or the righthand guide rail (not visible).

The parallelogram guide 3.13 is in that case so constructed, as clarified in FIG. 4, that it forms with the normals to the collision direction, which in the exemplifying embodiment runs parallel to the guide rail 4, an angle w which is smaller than the arctangent of the coefficient of friction μ between the brake bodies 3.11 or 3.12 and the guide rail 4.

If now, for example due to mass inertias of the elevator cars 1, 2 running onto one another, vertical forces are introduced into the locking mechanism 3.10 or 3.20, then these are transmitted by the parallelogram guide 3.13 to the brake bodies 3.11, 3.12. For example, in FIG. 4 such inertia forces, which are to be supported, from the upper elevator car 1 act in vertical direction downwardly on the first locking mechanism 3.10. If such vertical loads increase, then due to the parallelogram guide 3.13 set out against the collision direction these cause yet a further advance movement of the brake bodies 3.11, 3.12 towards the guide rail 4. The normal forces acting in frictional contact between brake bodies 3.11, 3.12 and guide rail 4 and thus the friction forces supporting the vertical loads are thereby further increased, the locking mechanism thus acting in self-locking manner.

As soon as the brake bodies of the brake body arrangements of the locking mechanisms come into contact with the guide rail 4 they dissipatively counteract movement of the two elevator cars 1, 2 up to one another. As soon as the elevator cars 1, 2 have approached one another to sufficient extent, i.e. the brake body arrangements have been displaced to sufficient extent in collision direction, sufficiently high normal forces act, due to the positive guide, in the frictional contacts between brake body arrangement and guide rail, so that the locking mechanisms adhere to the guide rail. In that case the two elevator cars 1, 2 initially travel further towards one another, wherein the spring-damper elements 5 deflect under partial energy dissipation and oppose the reaction forces which correspond with the elevator cars 1, 2 moving onto one another and which brake the elevator cars. These reaction forces are dissipated directly into the guide structure 4 by way of the frictional contact.

FIG. 2 shows a state in which the two elevator cars 1, 2 have approached up to a distance D′ wherein the spring-damper elements 5 between the locking mechanisms 3.10, 3.20, which are fixed by friction lock to the guide structure 4, and the elevator cars 1, 2 are compressed so that the elevator cars are supported on the locking mechanisms by way of the spring-damper elements.

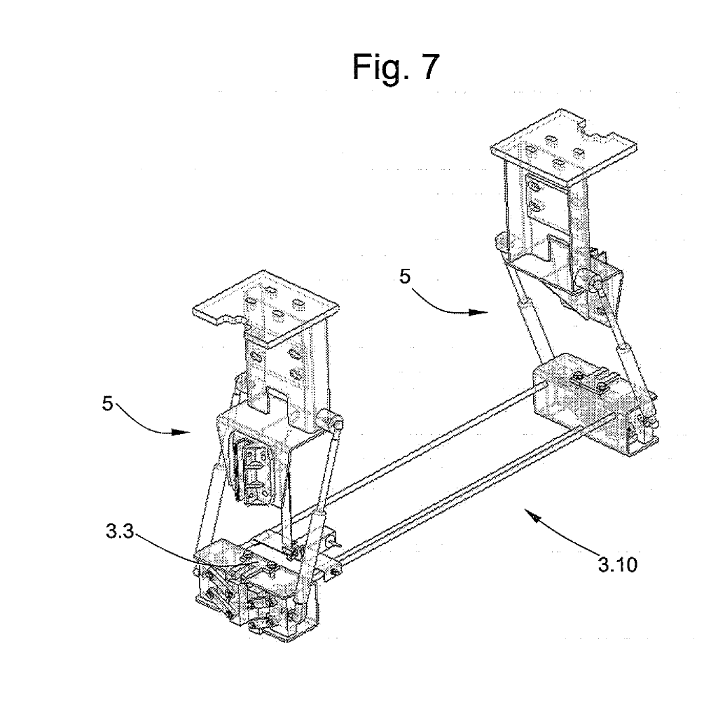

FIG. 7 shows a first locking mechanism 3.10 of an alternative embodiment of a collision brake according to the present invention. By contrast to the otherwise constructionally identical embodiment, which was explained in the foregoing with reference to FIGS. 1 to 6 and to the description of which reference is made to that extent, here the locking mechanisms are not only supported on the elevator cars by way of the spring-damper elements 5, but also directly fastened, wherein the spring-damper elements are constructed in the form of hydraulic damper arrangements 5 which in a trapezium-shaped parallelogram guide support the elevator cars relative to the locking mechanism. In FIG. 7 there can be seen at the upper T-beams, which are to be connected with the elevator car (not illustrated), a U-shaped guide which like the guide counter-member 3.3 on the locking mechanism 3.10 engages around the guide rail (not illustrated). The elevator car and locking mechanism are thus guided in travel direction at the same guide rail.

A collision brake according to an embodiment of the present invention acts in the same manner when the upper elevator car 1 travels towards the lower elevator car 2, which is stationary or moving in the same travel direction at a lower speed, when the lower elevator car 2 travels towards the upper elevator car 1, which is stationary or moving in the same direction at a lower speed, or when the two elevator cars 1, 2 move towards one another with opposite directions of travel.

The locking mechanisms 3.10, 3.20 are, through the contact, applied on each occasion and support the respective elevator car in friction-locking manner at the guide rail 4, so that its inertia forces are dissipated by way of the spring-damper elements 5 and the locking mechanisms 3.10, 3.20 into the environment of the elevator system and are not effective as collision forces between the two elevator cars 1, 2. Thus, advantageously a wedging of the two elevator cars 1, 2 in the case of collision is avoided, so that the car structure remains substantially intact in the event of an impact and the risk of injury to passengers is reduced.

The collision brake is reliably triggered by the contact by virtue of the positive guide and applied purely mechanically independently of an external energy supply. Moreover, it has a constructionally simple form.

In a modification (not illustrated) the collision brake is additionally or alternatively arranged at counterweights coupled with the elevator cars 1, 2 and is effective in the case of running of the two counterweights up to one another. For this purpose, the upper and lower elevator cars 1, 2 are simply to be regarded as replaced in the described figures by corresponding counterweights.

In accordance with the provisions of the patent statutes, the present invention has been described in what is considered to represent its preferred embodiment. However, it should be noted that the invention can be practiced otherwise than as specifically illustrated and described without departing from its spirit or scope.

1. Collision brake for two lift bodies (1, 2) moving independently of one another, comprising a first locking mechanism (3.10), which is arranged between the two lift bodies and fastened to a first one (1) of the two lift bodies and which comprises a brake body arrangement with at least one first brake body (3.11, 3.12), which is mounted in the first locking mechanism to be movable relative to a guide structure (4), characterised in that the first locking mechanism has a positive guide (3.13) which converts a relative movement of this brake body arrangement in a collision direction by the second one of the two lift bodies into a relative movement of the brake body arrangement at the guide structure.

2. Collision brake according to claim 1, characterised by a second locking mechanism (3.20), which is arranged between the two lift bodies and fastened to the second (2) lift body and which comprises a brake body arrangement with at least one first brake body which is mounted in the second locking mechanism to be movable relative to the guide structure, the second locking mechanism having a positive guide which converts a relative movement of this brake body arrangement in a collision direction by the first of the two lift bodies into a relative movement of the brake body arrangement at the guide structure.

3. Collision brake according to claim 2, characterised in that the first and second locking mechanisms are so constructed that on approach of the two lift bodies the brake body arrangements thereof come into direct or indirect contact and thus produce the relative movements of the brake body arrangements in the collision direction.

4. Collision brake according to any one of the preceding claims, characterised in that a brake body arrangement of a locking mechanism (3.10, 3.20) comprises a first and a second brake body (3.11, 3.12), which are mounted in this locking mechanism to be movable relative to one another and towards the guide structure.

5. Collision brake according to claim 4, characterised in that the first and the second brake bodies of the brake body arrangement are resiliently biased away from the guide structure, in particular by at least one release spring (3.14).

6. Collision brake according to one of the preceding claims 4 and 5, characterised in that the first and second brake bodies of the brake body arrangement are so coupled (3.15) together that an advance movement of one of the first and second brake bodies towards the guide structure causes an advance movement, which in particular is symmetrical with respect thereto, of the other one of the first and second brake bodies.

7. Collision brake according to any one of the preceding claims, characterised in that the positive guide converting the relative movement of one brake body arrangement in the collision direction into a relative movement at the guide structure comprises a parallelogram guide (3.13) of the brake body arrangement.

8. Collision brake according to any one of the preceding claims, characterised in that the brake body arrangement has self-locking co-operation with the guide structure when it bears against the guide structure.

9. Collision brake according to the preceding claims 7 and 8, characterised in that the parallel guide forms with the normals to the collision direction an angle (w) which is smaller than or equal to the arctangent of the coefficient of friction (μ) between the brake body arrangement and the guide structure (w≦arctan(μ)).

10. Collision brake according to any one of the preceding claims, characterised in that a locking mechanism is fastened to or supported at a lift body by way of a spring element and/or damper element (5).

11. Collision brake according to claim 10, characterised in that the spring element and/or damper element is so constructed that in the case of a collision speed in the range between 0.5 and 1.5 m/s a deceleration, particularly a substantially constant deceleration, in the region of 1 g arises.

12. Collision brake according to one of the preceding claims 10 and 11, characterised in that the damper element (5) comprises a rubber element, a mechanical damper, a hydraulic damper and/or a pneumatic damper.

13. Collision brake according to any one of the preceding claims, characterised in that a locking mechanism (3.10, 3.20) is fixedly connected with a lift body or mounted thereat to be floating.

14. Collision brake according to any one of the preceding claims, characterised in that the lift bodies form lift cages and/or counterweights.

15. Collision brake according to any one of the preceding claims, characterised in that the guide structure is constructed parallel to the collision direction.

16. Collision brake according to any one of the preceding claims, characterised in that the guide structure comprises one or more guide rails (4).

17. Collision brake according to any one of the preceding claims, characterised in that the lift bodies are guided at the guide structure.

18. Lift system with two lift bodies (1, 2) moving independently of one another and a collision brake according to any one of the preceding claims.
